(19) United States
(12) Patent Application Publication
(10) Pub. No.: US 2002/0042686 A1
(43) Pub. Date: Apr. 11, 2002

(54) Residual chlorine meter and residual chlorine measuring method

(75) Inventors: Takeshi Kobayashi, Kyoto (JP); Takeshi Mori, Kyoto (JP)

Correspondence Address: SUGHRUE, MION, ZINN, MACPEAK & SEAS, PLLC, 2100 Pennsylvania Avenue, N.W., Washington, DC, 20037, US

(73) Assignee: HORIBA, LTD.

(21) Appl. No.: 09/969,723

(22) Filed: Oct. 4, 2001

(30) Foreign Application Priority Data
Oct. 5, 2000 (JP) P. 2000-305888

(51) Int. Cl. G01F 1/12; G01F 1/50; G06F 19/00; G01L 27/00

(52) U.S. Cl. 702/100

(57) ABSTRACT

A residual chlorine meter, which is easy to calibrate and enables measurement results of good precision to be obtained, wherein an oxygen reduction voltage of for example −1V is applied across an anode electrode and a cathode electrode when the power is turned ON with a sensor part being in air (step S1), the polarographic current corresponding to the concentration of oxygen in air is detected (step S3), span calibration is performed based on this detection result (step S4), the voltage applied across the electrodes is then switched (step S6), and the residual chlorine concentration of the sample solution is measured (step S7). By thus performing span calibration based on the oxygen concentration of air, a calibration standard solution containing a predetermined concentration of residual chlorine does not have to be prepared, making the calibration procedure easy and enabling measurement results of good precision to be obtained.

### BACKGROUND OF THE INVENTION

1. Field of the Invention

This invention relates to a residual chlorine meter, which is used for measurement of the concentration of residual chlorine (hypochlorous acid, chlorine gas, etc.).

2. Description of the Conventional Art

With drinking water, industrial wastewater, and water that is to be used in pools, baths, in leisure facilities, etc., sodium hypochlorite is added to disinfect and sterilize the water. Since the amount of residual chlorine increases and can give rise to carcinogenic trihalomethane when an excessive amount of sodium hypochlorite is used, the residual chlorine must be monitored. Methods for measuring the residual chlorine include calorimetric methods and amperometric titration methods, and residual chlorine meters, based on the polarography method, have been put to practical use as a general means for measuring the residual chlorine.

This type of residual chlorine meter is arranged to apply a fixed voltage across an anode electrode, which for example is made of gold, and a cathode electrode, which for example is made of silver, and detect the reduction polarographic current that flows across the electrodes in this process to determine the residual chlorine concentration from the value of the current (see for example, Japanese patent publication No. Hei 10-82761).

With such a residual chlorine meter, for example the silver cathode electrode, the electrolytic solution provided between the electrodes, etc. gradually degrade as measurements are made in the above-described manner, and the sensitivity thus tends to change readily. Span calibration must therefore be performed as necessary to maintain the precision of measurement. Conventionally, span calibration was performed upon preparing a standard solution containing a predetermined concentration of residual chlorine.

However, preparing such a standard solution each time span calibration is to be performed makes the work troublesome, and since even with a standard solution, the residual chlorine contained therein diffuses into the atmosphere and thus changes in concentration readily, accurate span calibration is difficult to perform and thus good measurement precision cannot be maintained necessarily.

### SUMMARY OF THE INVENTION

This invention has been made in view of the above problem, and an object thereof is to provide a residual chlorine meter, with which span calibration can be performed readily and which enables measurement results of good precision to be obtained.

In order to achieve the above object, according to the first aspect of the invention, a residual chlorine meter comprises: a sensor part, which is equipped with an anode electrode and a cathode electrode; an arithmetic processing means, which detects the polarographic current that flows across the electrodes when a predetermined residual chlorine reduction voltage is applied across the electrodes and calculates the residual chlorine concentration; a calibration voltage application means, which applies across the electrodes an oxygen reduction voltage that differs from the abovementioned residual chlorine reduction voltage, and a span calibration control means, which performs span calibration based on the polarographic current that flows across the electrodes when the oxygen reduction voltage is applied across the electrodes with the abovementioned sensor part being in an air atmosphere.

With this residual chlorine meter, the measurement of residual chlorine concentration is performed by applying, as the residual chlorine reduction voltage, a voltage across the anode and cathode electrodes, that is for example, a voltage of approximately 50 mV, by which the rate of reaction of the reduction reaction, HClO+e⁻→(½)H₂ +ClO⁻, which occurs at the anode electrode, becomes sufficiently higher than the rate of diffusion of residual chlorine towards the anode electrode, and detecting the polarographic current, which flows in proportion to the residual chlorine concentration in this process. Also, the voltage applied across the anode and cathode electrodes may be changed to a voltage of approximately −1V for example and applied across the electrodes as the oxygen reduction voltage so that a polarographic current, based on the reduction reaction of the oxygen that diffuses towards the cathode electrode, will flow across the electrodes.

Thus with the above-described arrangement, the above-mentioned oxygen reduction voltage is applied, for example prior to the start of measurement of the residual chlorine concentration and in the condition where the sensor part is in an air atmosphere, the polarographic current, which flows in correspondence to the oxygen concentration of air is detected, and span calibration that is in accordance with the sensitivity variation of the sensor part is performed based on the detection result.

There is thus no need to prepare a standard solution containing a predetermined concentration of residual chlorine as in the prior art, and since span calibration is performed based on the oxygen concentration of air, which is fixed, the calibration procedure is easy to perform and enables measurement results of good precision to be obtained.

The residual chlorine meter of the second aspect of the invention, in the residual chlorine meter, the above-mentioned oxygen reduction voltage is applied across the electrodes and span calibration is performed each time the power ON operation is performed.

With this arrangement, span calibration is performed automatically at the point in time at which the power ON operation is performed in order to measure the residual chlorine concentration. By then performing the procedure of immersing the sensor part in the sample liquid and measuring the residual chlorine concentration, a measurement result of good precision can be obtained without fail by a simple procedure in each measurement.

As has been described above, with the residual chlorine meter of this invention, span calibration is performed by applying an oxygen reduction voltage across the anode electrode and the cathode electrode in the condition where the sensor part is in an air atmosphere and detecting the polarographic current that flows in correspondence to the oxygen concentration of air at this time, there is no need to prepare a standard solution containing a predetermined concentration of residual chlorine as in the prior art. The calibration procedure is thereby made easy and good measurement precision can be maintained.

### DESCRIPTION OF THE DRAWINGS

FIG. 1 is a flowchart, which shows the control procedure that is carried out by the residual chlorine meter of an embodiment of this invention when the power is turned ON;

FIG. 2 is a perspective view, which shows the outer appearance of the abovementioned residual chlorine meter;

FIG. 3A is a plan view showing the sensor part incorporated in the abovementioned residual chlorine meter;

FIG. 3B is an exploded perspective view showing the sensor part; and

FIG. 4 is a control block diagram, which shows the arrangement of the control circuit in the abovementioned residual chlorine meter.

### DESCRIPTION OF THE PREFERRED EMBODIMENTS

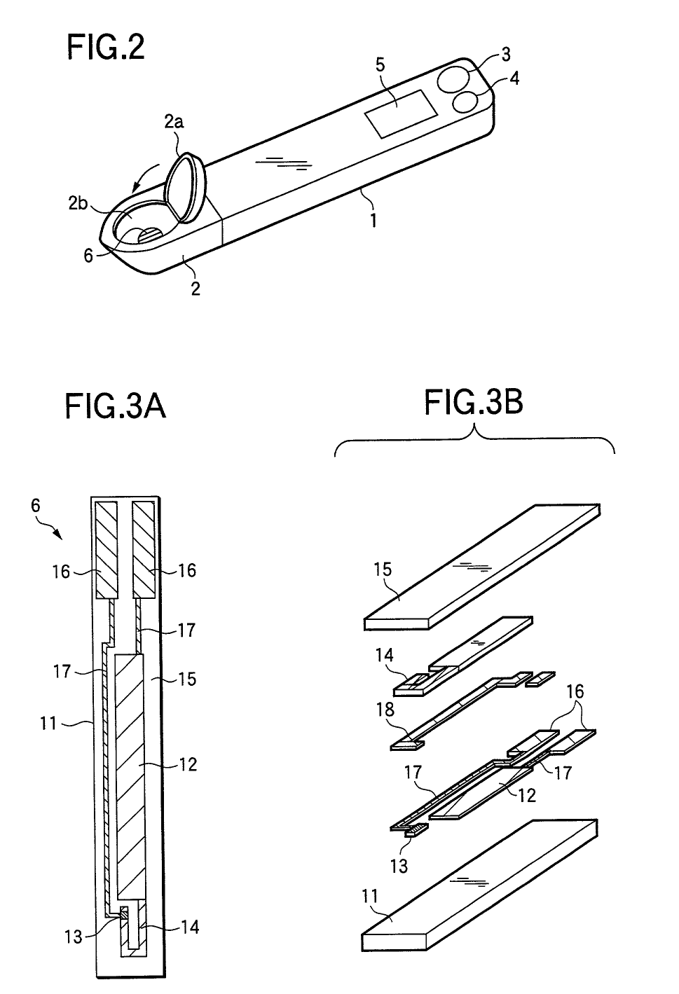

An embodiment of this invention shall now be described in detail with reference to the drawings. As shown in FIG. 2, the residual chlorine meter of this embodiment is arranged by providing a base case part 1, of substantially square rod shape, and a liquid detection part 2, which is connected integrally to the front end of base case part 1. The total length is approximately 150 mm and this arrangement thus provides a portable residual chlorine meter that can be held and carried with one hand. On the upper face at the rear end side (the upper right side in the Fig.) of base case part 1, a power switch 3, a measurement starting switch 4, and a digital display part 5, comprised of a liquid crystal display plate, are provided and a control circuit to be described below is housed along with a battery, etc. in the interior.

Meanwhile, a cap 2a, which can be opened and closed with the fingertips, is mounted to the upper face of liquid detection part 2. A liquid chamber 2b, which is recessed downwards in substantially semispherical form, is formed at the lower side of cap 2, and a chlorine sensor (sensor part) 6 is disposed at the bottom part of this liquid chamber 2b.

Chlorine sensor 6 is formed by successively providing a rectangular cathode electrode 12, a small-area square anode electrode 13, an electrolytic membrane 14, which lies across electrodes 12 and 13, and a barrier membrane 15, which covers the above components, as shown in FIG. 3B on a strip-like substrate 11, such as shown in FIG. 3A, of dimensions of approximately 2 mm width×15 mm length×0.5 mm thickness, using a photolithography technique that is employed in semiconductor manufacturing processes. In this Figure, 16 indicates pad parts for taking out the current and 17 indicates lead wires for connecting pad parts 16 to cathode electrode 12 and anode electrode 13, respectively.

A silicon substrate, having an insulating oxide film formed on the surface thereof, is employed as substrate 11, and pad parts 16 and lead parts 17 are formed on substrate 11 by vapor deposition of Ag followed by patterning using a photolithography technique. An insulating film 18, comprised of polyimide resin, is then formed on areas that cover lead parts 17. Then after successively forming the cathode electrode 12, which is comprised of Ag, and the anode electrode 13, which is comprised of Au, the electrolytic membrane 14, which is made by blending and gelling KCl and modified PVP, is formed on the area across cathode electrode 12 and anode electrode 13 by screen printing. Thereafter, the barrier membrane 15, which is comprised of modified silicone resin, is provided so as to cover the entire surface with the exception of pad parts 16 to thereby form the abovementioned chlorine sensor 6. Chlorine sensor 6 of such an arrangement is mounted to the bottom part of liquid chamber 2b of the above-described liquid detection part 2 in the condition where the surface of barrier membrane 15 is exposed to the upper side.

With the residual chlorine meter of the above-described arrangement, the concentration of residual chlorine is measured by the polarographic method. That is, sample water is injected or scooped into the liquid chamber 2b of liquid detection part 2, and when measurement starting switch 4 is pressed upon closing cap 2a, a predetermined voltage, for example, a voltage of 50 mV is applied across cathode electrode 12 and anode electrode 13. If at this time, residual chlorine (HClO) is contained in the sample water, the following reactions occur at the respective electrodes 12 and 13:

Cathode electrode (Ag): Ag→Ag⁺+e⁻

Anode electrode (Au): HClO+e⁻→(½)H₂ +ClO⁻

That is, the residual chlorine contained in the sample water permeates through the barrier membrane 15, the reduction reaction of this residual chlorine occurs at anode electrode 13, and the reduction polarographic current, which accompanies this reaction, flows across electrodes 12 and 13. This current value is detected, converted into a numerical value that corresponds to the concentration of the residual chlorine in the sample water, and displayed on the abovementioned digital display part 5.

With a device, by which the residual chlorine is measured based on the above-described polarography method, the cathode electrode 12 is gradually consumed and the ratios of the components in electrolytic membrane 14 change gradually as measurements are made. Therefore, the sensor life, during which good measurement precision can be maintained, is, for example, about 200 times of measurement. Since the sensitivity also changes gradually in accompaniment with the abovementioned changes, the measurement precision is maintained by performing span calibration at appropriate times.

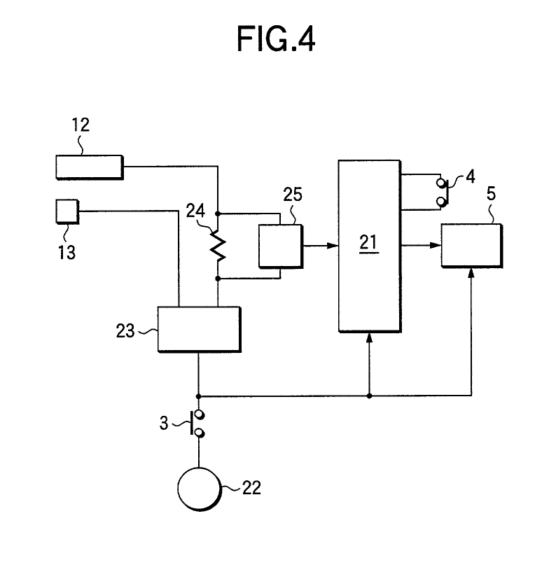

With the residual chlorine meter of the present embodiment, the abovementioned span calibration is performed automatically based on the oxygen concentration of air each time power switch 3 is turned ON. The arrangement for this operation shall now be described with reference to FIG. 4.

This Figure shows the arrangement of the control circuit that is incorporated inside the abovementioned base case part 1. In this Figure, 21 is a signal processing control unit, comprised for example of a microcomputer, and the processing procedure for the residual chlorine measurement mode, which has been described above, and the span calibration procedure, which shall be described below, are stored in signal processing control unit 21. Also inside base case part 1 is provided an applied voltage control circuit (calibration voltage application means) 23, which converts the power voltage supplied from a battery 22 into a predetermined voltage and applies this voltage across the above-described cathode electrode 12 and anode electrode 13 in accordance to command signals from signal processing control unit 21.

A detection resistor 24 is interposed in the lead wire that connects applied voltage control circuit 23 and, for example, cathode electrode 12, and the voltage, which is generated at the abovementioned detection resistor 24 in accordance with the value of the current that flows across the electrodes 12 and 13, is input into signal processing control unit 21 via an amplifier 25. The arithmetic processing of converting the abovementioned measured voltage into residual chlorine concentration is performed by the signal processing control unit 21, which serves the function of an arithmetic processing means during the above-described measurement of the residual chlorine concentration, and the result of this arithmetic processing is displayed on the abovementioned digital display part 5.

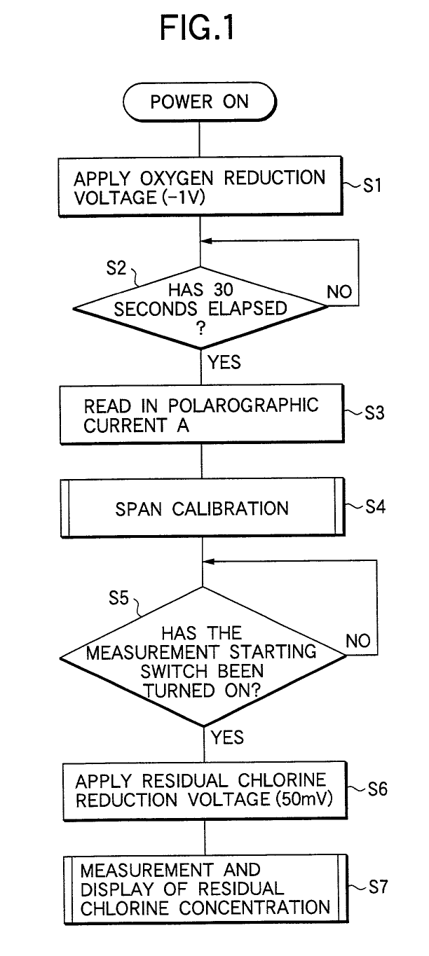

With the above-described arrangement, when the ON operation of power switch 3 is performed and the power from battery 22 is supplied to signal processing control unit 21, first the span calibration processing procedure is started automatically by control unit 21, which also functions as the span calibration control means. In this process, a voltage generation command signal, for making a voltage, for example, of −1V, which is inverted in voltage polarity with respect to the voltage used for the above-described residual chlorine measurement process, be applied across cathode electrode 12 and anode electrode 13 as indicated in step S1 of FIG. 1, is sent to applied voltage control circuit 23. This applied voltage is set in accordance with the reduction voltage of oxygen. At this time, the abovementioned liquid chamber 2b of liquid detection part 2 is empty, chlorine sensor 6 is exposed to an air atmosphere, and in this condition, the following reactions occur at the respective electrodes 12 and 13:

Cathode electrode (Ag): Ag→Ag⁺+e⁻

Anode electrode (Au): O₂+2H₂O+4e⁻→4OH⁻

That is, the oxygen in air permeates through barrier membrane 15 and becomes dissolved in electrolytic membrane 14 so that the reduction reaction of the dissolved oxygen will occur at anode electrode 13 and the reduction polarographic current, corresponding to the concentration of oxygen in air (23.2%), will flow across the electrodes 12 and 13. In actuality, the elapse of approximately 30 seconds, from the point in time at which the application of the oxygen reduction voltage is started, is waited for in order to let the reaction reach the equilibrium condition (step S2), the polarographic current value A at the point in time at which equilibrium is reached is then read in (step S3), and the span calibration calculation process is performed based on this current value A (step S4).

This span calibration calculation process is performed as follows. That is, if, for example, 4 nA is the polarographic current value at the time of the initial sensitivity adjustment that is performed using a standard sample containing 2.00 ppm of residual chlorine, and the polarographic current value, which corresponds to the concentration of oxygen in air and is measured by application of the oxygen reduction voltage in the manner described above, is 40 nA, the span calibration factor S is determined by the calculation:

S(ppm)=2.00(ppm/nA)×4(nA)/[A(nA)/40(nA)]

and stored each time the power is turned ON.

When this span calibration calculation process is ended, the application of the oxygen reduction voltage is stopped and the condition of standby until the input of the measurement starting signal in accompaniment with the pressing of the abovementioned measurement starting switch 4 is entered (step S5). During this time, the measurer places the sample water to be measured in liquid chamber 2b of liquid detection part 2, and when the measurement starting switch 4 is pressed thereafter, a voltage generating command signal, which causes the abovementioned chlorine reduction voltage of 50 mV to be applied across cathode electrode 12 and anode electrode 13, is sent from signal processing control unit 21 to applied voltage control circuit 23 in step S6.

The residual chlorine concentration of the measurement sample water is thereby measured as has been described above and the measured value is displayed on digital display part 5 (step S7) . That is, if the polarographic current value for the measurement sample liquid is B(nA), the residual chlorine concentration C of the measurement sample liquid is determined by the calculation:

C(ppm)=B(nA)×S(ppm)×f(t)/4(nA)

and is displayed on digital display part 5. In the above formula, f(t) is a correction function corresponding to the temperature characteristics of the sensor. That is, the residual chlorine concentration C is determined upon performing a temperature correction using a correction function value calculated in accordance with the temperature detected by an unillustrated temperature sensor.

The residual chlorine concentration C that has been calculated in the manner described above is displayed on digital display part 5, and by reading the value for example after the elapse of 30 seconds at which time the value has stabilized, errors due to the measurer or the timing at which the measured value is viewed can be prevented and a measurement result of good precision can be obtained.

As has been described above, with the residual chlorine meter of the present embodiment, span calibration based on the oxygen concentration of air is performed by switching the reduction voltage applied across cathode electrode 12 and anode electrode 13. A standard solution, etc. for calibration is therefore unnecessary, and since span calibration is performed automatically each time the operation of turning ON the power switch 3 is performed, the operations, including that for span calibration, are extremely simple and a measurement result of good precision can be obtained in each measurement.

Also, with the residual chlorine meter of this embodiment, chlorine sensor (sensor part) 6 has an arrangement wherein electrodes 12 and 13, etc. are provided on silicon substrate 11 by employment of a photolithography technique that is used in semiconductor manufacturing processes, etc. a gelled electrolytic membrane 14 is formed by a screen printing method, and the surface is covered by barrier membrane 15. Chlorine sensor 6 is thus formed to be of extremely compact size. The entire residual chlorine meter is thus made compact and portable, and since it can thus be readily carried anywhere, it is extremely high in operability and excellent in the ease of use. Also by the provision of barrier membrane 15 at sensor part 6 as has been described above, the sensor is made less likely to be effect by other interfering ions, and the measurement precision is improved thereby as well.

With the above-described chlorine meter, not only free residual chlorine such as HOCl, OCl⁻, etc., but bound residual chlorine, such as NH₂Cl, NHCl₂, NCl₃, etc., may also be measured by placing the sample liquid in liquid chamber 2b of liquid detection part 2 and thereafter placing KI and an acidic buffer of a pH of approximately 4.

Though an embodiment of this invention has been described above, this invention is not limited to this embodiment and various modifications are possible within the scope of the invention. For example, though a residual chlorine meter, equipped with a sensor 6 having a barrier membrane 15 made of modified silicone resin on the surface, was described above, an arrangement, which uses a porous polyethylene film or a dialytic membrane of small pore size as the abovementioned barrier membrane, is also possible. The present invention may also be applied to other forms of residual chlorine meters, which use the polarographic method and are not equipped with an above-described type of barrier membrane.

What is claimed is:

1. A residual chlorine meter comprising:
a sensor part, which is equipped with an anode electrode and a cathode electrode;
an arithmetic processing means, which detects the polarographic current that flows across the electrodes when a predetermined residual chlorine reduction voltage is applied across the electrodes and calculates the residual chlorine concentration;
a calibration voltage application means, which applies across the electrodes an oxygen reduction voltage that differs from said residual chlorine reduction voltage; and
a span calibration control means, which performs span calibration based on the polarographic current that flows across the electrodes when the oxygen reduction voltage is applied across the electrodes with said sensor part being in an air atmosphere.

2. A residual chlorine meter as set forth in claim 1, wherein said oxygen reduction voltage is applied across the electrodes and span calibration is performed each time the power ON operation is performed.

3. A residual chlorine measuring method using a residual chlorine meter comprising a sensor part, which is equipped with an anode electrode and a cathode electrode and an arithmetic processing means, which detects the polarographic current that flows across the electrodes when a predetermined residual chlorine reduction voltage is applied across the electrodes and calculates the residual chlorine concentration, said method comprising the steps of:
applying an oxygen reduction voltage that differs from said residual chlorine reduction voltage as a calibration voltage across the electrodes;
performing span calibration based on the polarographic current that flows across the electrodes when the oxygen reduction voltage is applied across the electrodes with said sensor part being in an air atmosphere.

4. A residual chlorine measuring method as set forth in claim 3, wherein said oxygen reduction voltage is applied across the electrodes and span calibration is performed each time the power ON operation is performed.
